(19) United States
(12) Patent Application Publication
(10) Pub. No.: US 2020/0078874 A1
(43) Pub. Date: Mar. 12, 2020

(54) Tool Length Adjustment System

(71) Applicant: The Tapmatic Corporation, Post Falls, ID (US)

(72) Inventor: Mark F. Johnson, Harrison, ID (US)

(73) Assignee: The Tapmatic Corporation, Post Falls, ID (US)

(21) Appl. No.: 16/123,901

(22) Filed: Sep. 6, 2018

(51) Int. Cl. B23B 51/12; B23Q 3/10

(52) U.S. Cl. CPC B23B 51/126; B23B 2260/078; B23B 2260/004; B23Q 3/107

(57) ABSTRACT

Disclosed is a tool length adjustment system which allows the tool length to be adjusted without removing the tool from the tool holder. The tool length can be adjusted through the combination of an external circumferential adjustment ring which can be rotated while the tool is in the tool holder, thereby driving an adjustment key built into the tool holder via the use of drive balls which ultimately cause the rotation of the adjustment key.

### CROSS REFERENCE TO RELATED APPLICATION

This application does not claim priority from any other application.

### TECHNICAL FIELD

This invention pertains to a tool length adjustment system, more preferably, to a tool length adjustment system for tool (or tool holder) combinations for taps/tap-holders and drills/drill-holders.

### BACKGROUND OF THE INVENTION

When utilizing tools such as taps, drills or others, there are times when it is desirable or necessary to change or adjust the length of the tool and holder. This desire or need may be caused by any one of a number of different factors, including the drill or tap has incurred some wear, or has been re-sharpened, which in turn has changed the overall tool length. It is desirable in many operations to maintain the tapping or drilling depths in the work piece so they are consistent during each operation.

In order to maintain the depth accuracy desired for the operation, it is then necessary and sometimes tedious with the prior art, to change or adjust the tool length (which is normally a combined length of the tool holder such as a tap holder or drill holder, combined with the tool being held or secured within the holder (the tool being a tap or a drill for example).

A common way to adjust the vertical position of a tap or drill in a tool holder is to have a screw inside the tool holder and that screw for example acts as a stop for the back of the tap or drill. In these prior art length adjustment systems, the screws are typically turned one direction to push the tap forward in the collet, or turned in the opposite direction, the retraction direction, to allow the tap or drill to go deeper into the tool holder. To adjust the screw as described in the prior art, the user normally has to take a drill or tap out of the machine that is retaining it, adjust the screw, and re-insert the drill or tap back into the holder and then re-measure the length. Sometimes this process takes several rounds of adjustment in rechecking the length in order to achieve the desired depth.

A problem inherent with the prior art requiring that the drill or tap be removed and then reinserted in order to adjust the tool length, is that it takes much more employee time and the production of the machine is down during this time.

It is an object of applications of some embodiments of this invention to provide a tool length adjustment system which does not require that the tool be removed from the tool holder.

Embodiments of this invention have the advantage of providing an adjustment system for changing the tool length without being required to take the tool (a tap or a drill) out of the tool holder, which thereby makes the adjustment quicker and easier to get to the desired tool length. In order to achieve this particular advantage to the invention, some embodiments of this invention utilizes adjustment balls which act as a drive mechanism and in a similar fashion to gears, in order to turn a key that is built into the tool holder.

Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is an exploded elevation view of one example of a tool length adjustment system contemplated by one embodiment of this invention;

FIG. 2 is an elevation view of part of the assembled example of the embodiment of the tool length adjustment system illustrated in FIG. 1;

FIG. 3 is cross section C-C identified in FIG. 2;

FIG. 4 is an elevation cross-sectional view A-A of the embodiment shown in FIG. 2;

FIG. 5 is an exploded view of certain of the operational components of the examples of the embodiment of the invention illustrated in FIG. 1;

FIG. 6 is the same cross-section C-C identified in FIG. 2, only illustrating a different embodiment wherein there is one adjustment wheel per adjustment aperture instead of two adjustment balls; and

FIG. 7 is the same cross-section C-C identified in FIG. 2, only illustrating a different embodiment wherein adjustment gears replace the adjustment balls shown in FIG. 3.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

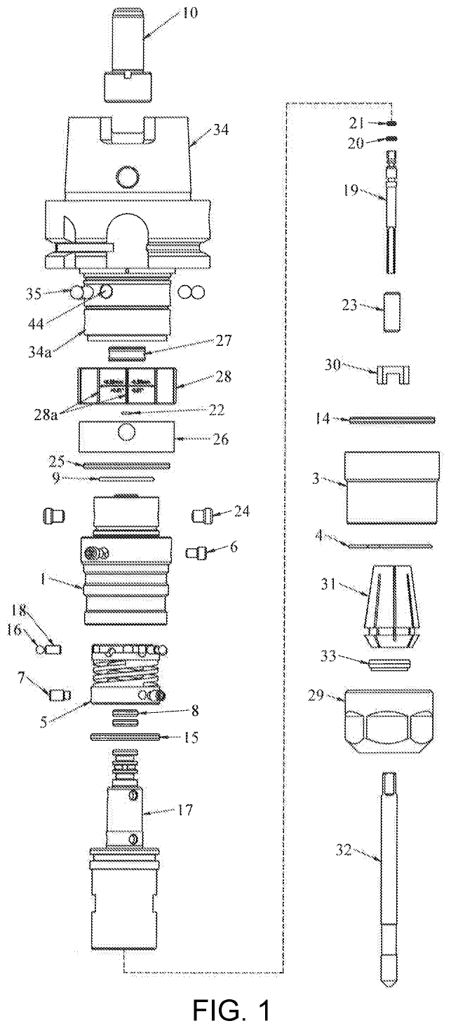

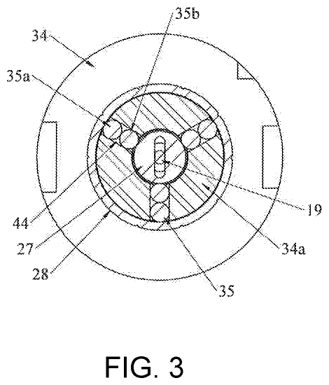

FIG. 1 is an exploded elevation view of one example of a tool length adjustment system contemplated by one embodiment of this invention. FIG. 1 illustrates floating nozzle 10, tool holder shank 34, adjustment balls 35 (which may be viewed as acting as drive balls or as gears of sorts), which are adjustment members, in adjustment ball apertures 44 (also see FIG. 3), adjustment sun 27, adjustment ring 28 shown circumferentially around lower portion 34a of tool holder shank 34 (and with multiple adjustment lines 28a thereon), adjustment retaining clip 22, sleeve for adjustment shanks 26, O-ring 25, O-ring 9, screw pin 24, flexure retaining screw 6, housing 1, steel ball 16, drive pin 18, lower drive screw 7, O-ring 8, O-ring 15, drive spindle for adjustment 17, O-rings 20 & 21, adjustment key 19, adjustment or adjusting screw 23, driver 30 (the driver is optional and may be used if a square interconnection is utilized in the particular embodiment of the invention), O-ring 14, identification sleeve 3, sleeve retaining ring 4, collet 31, seal 33, seal disk nut 29, tool 32 (a tap or a drill bit) and helically cut flexure body 5.

The adjustment key 19 rotatably attached at a top end to the adjustment sun 27 and rotatably attached at a bottom end to an adjustment screw 23. By rotatably attached, the adjustment key 19 is attached such that it rotates with the adjustment sun 27 at the top end and rotates with the adjustment screw 23 at the bottom end. The attachment may be any one of a number of different types of attachments, such as a fixed or permanent attachment, or one which may be disassembled such as shown in the figures, with no one in particular being required to practice the invention.

A review of FIG. 1 combined with FIG. 3 illustrates how the adjustment balls 35 are placed within the lower portion 34a of the shank 34, in this example of an embodiment, there are two adjustment balls 35 placed in each of the three adjustment ball apertures 44 in the lower portion 34a of the tool holder shank 34.

It should be noted that while the drawings show two adjustment balls 35 per each of the three adjustment ball apertures 44, this invention is not limited to an application utilizing two adjustment balls or three adjustment ball apertures 44. Instead, any one of a number of adjustment balls 35 per adjustment ball aperture 44 may be used in practicing this invention (including without limitation, one, three or four) with no one in particular being required to practice this invention. Still further, one, two, three, four, or five adjustment ball apertures 44 may be used in practicing this invention, with no particular number being required.

In a two adjustment ball (per adjustment aperture) configuration such as shown in the figures, the outermost adjustment ball 35a is in direct contact with the interior surface of the adjustment ring 28 and with the innermost adjustment ball 35b (shown in FIG. 3). In the two adjustment ball configuration, when the adjustment ring 28 is rotated, it causes the outermost adjustment ball 35a to rotate within the adjustment ball aperture 44, which in turn causes the innermost adjustment ball 35b to rotate in the opposite rotational direction to that of the outermost adjustment ball 35a. The innermost adjustment ball 35b is also in direct contact with the adjustment sun 27 and configured and disposed such that the innermost adjustment ball 35b causes the adjustment sun 27 to rotate when the innermost adjustment ball 35b rotates.

The adjustment sun 27 acts similar to a sun gear and the innermost adjustment balls 35b act similar to planetary gears as the adjustment ring 28 is rotated. Since a two adjustment ball configuration is used in this embodiment, the adjustment sun 27 turns in the same rotational direction as the adjustment ring 28. However, it should be noted that in embodiments utilizing a single adjustment ball in the adjustment aperture, the adjustment sun 27 would rotate in the opposite rotational direction of the adjustment ring 28.

The adjustment sun 27 is operably attached to the adjustment key 19 and disposed or configured such that when the adjustment sun 27 rotates, the adjustment key 19 rotates with it. The adjustment sun 27 can be operably attached to the adjustment key 19 in any one of a number of ways with no one particular being required to practice this invention—so long as the adjustment key 19 is directly or indirectly rotatably fixed to the adjustment sun 27.

In the embodiment shown in the figures, the adjustment key 19 has an upper end 19a operably attached to the adjustment sun 27 and a lower end 19b which is configured and disposed to operably attach to an adjusting screw 23. The adjusting screw 23 in this example of this embodiment is externally threaded and configured or disposed such that when it rotates it directly or indirectly causes the tool 32 (tap or drill bit) to move up and/or down with the rotation. In the embodiment shown, the lower end 19b of the adjustment key 19 is shaped in an “I” or “I-beam” shape such that it can easily slide in and out of the key aperture in the adjustment screw 23, thereby causing the adjustment screw 23 to rotate with the adjustment key 19. In the example of the embodiment shown, the I-beam cross-sectional configuration of the adjustment key 19 inserts into a hexagonal key aperture 23a in the adjustment screw and is thereby rotationally fixed with the adjustment screw 23 (but is still relatively easily removable).

There are different ways to practice this invention with the adjustment screw 23. In some embodiments the adjustment screw 23 can be configured to contact the back of the tool (cutting tool, tap or drill), or like shown in the drawing, the adjustment screw 23 can be configured to press against a driver 30 that has a slot 30a for receiving and securing the tap square (the tap square is a square shaped top end of a tap or drill for example, but can be any non-circular geometry that rotationally fixes the driver to the tool).

In the embodiment shown, the adjustment ring 28 is shown with adjustment lines 28a thereon, ten adjustment lines 28a in the embodiment shown. So when the adjustment ring 28 is rotated, the adjustment balls 35 are trapped between the adjustment ring 28 and the adjustment sun 27, which illustrates the gear-like function of the adjustment balls 35 in this embodiment.

The relative sizing of the adjustment ring 28 and adjustment sun 27 can be controlled to predetermine the relative rotations of the two components, which in this embodiment is preferred to be a 2.5 multiple. However, it will be noted that the relative diameter sizes of the adjustment ring 28 and the adjustment sun 27 may be any one of a number of different configurations, with no one in particular being required to practice this invention. In the embodiment of the invention where the two and one-half (2.5) multiple between the diameters is chosen, for each revolution of the adjustment ring 28 made, the adjustment sun 27 will rotate two and one-half (2.5) revolutions. In this embodiment if the screw pitch for the adjustment screw 23 is chosen to be one-millimeter (1 mm), then each revolution or rotation of the adjustment ring 28 will turn the adjustment sun two and one-half (2.5) revolutions, which would advance or retract the adjustment screw two and one-half millimeters (2.5 mm) due to the one-millimeter (1 mm) pitch of the adjustment screw 23.

The ten equally spaced adjustment lines 28a on the adjustment ring 28 then represents a one-quarter millimeter (0.25 mm) adjustment length, or a one one-hundredths of an inch (0.01 inches) tool length adjustment.

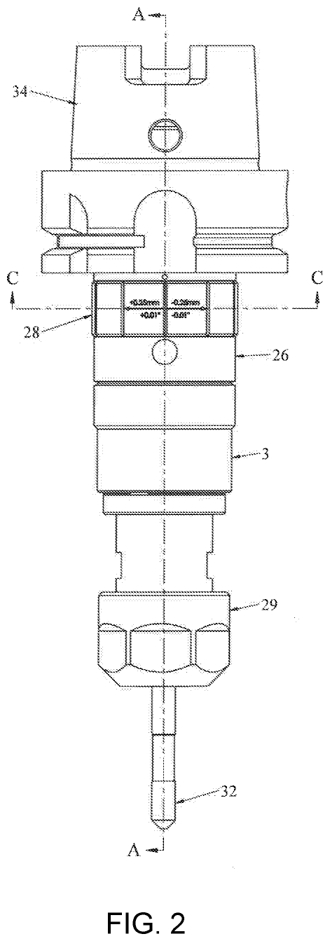

FIG. 2 is an elevation view of part of the assembled example of the embodiment of the tool length adjustment system illustrated in FIG. 1. FIG. 2 illustrates tool holder shank 34, adjustment ring 28, sleeve for adjustment shanks 26, identification sleeve 3, seal disk nut 29 and tool 32 (a tap or a drill bit).

FIG. 3 is an elevation cross section C-C identified in FIG. 2, and illustrates tool holder shank 34, adjustment ring 28, adjustment balls 35 in adjustment ball apertures 44, adjustment sun 27 and adjustment key 19. FIG. 3 shows an embodiment of the invention that utilizes three sets of two adjustment balls 35 per adjustment aperture 44, spaced one-hundred twenty degrees apart.

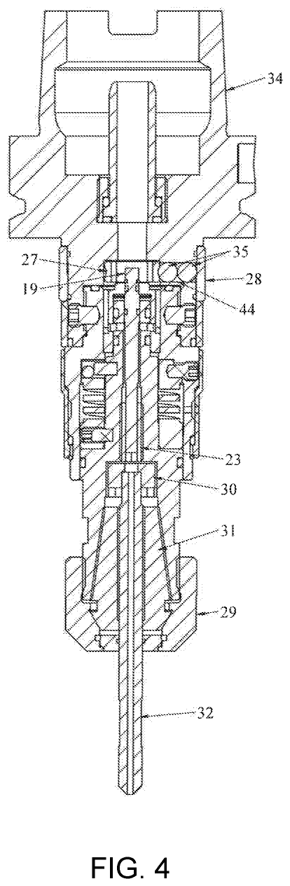

FIG. 4 is an elevation cross-sectional view A-A of the embodiment shown in FIG. 2. FIG. 4 illustrates tool holder shank 34, adjustment balls 35 in adjustment ball aperture 44, adjustment sun 27, adjustment ring 28, adjustment key 19, adjusting screw 23, driver square 30, collet 31, seal disk nut 29 and tool 32 (tap or drill bit).

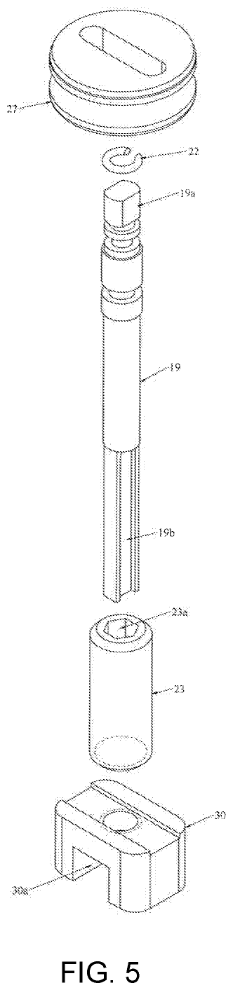

FIG. 5 is an exploded view of certain of the operational components of the examples of the embodiment of the invention illustrated in FIG. 1, illustrating adjustment sun 27, retaining ring 22, adjustment key 19, adjusting screw 23 and driver 30 (the driver is optional and may be used if a square interconnection is utilized in the particular embodiment of the invention).

In some applications users of the tool holders desire to provide lubricant through the tool holder and to the workpiece being drilled, tapped or cut. In the embodiment shown, the lower end of 19b of the adjustment key 19 is shaped in an “I” or “I-beam” shape such that it can easily slide in and out of the key aperture in the adjustment screw 23, thereby causing the adjustment screw 23 to rotate with the adjustment key 19. The I-beam configuration naturally provides lubricant passageways on both sides (along and down the adjustment screw 23) to allow the user to route lubricant through the tool holder (including past the adjustment key 19 and through the adjustment screw 23) and to the tool and workpiece.

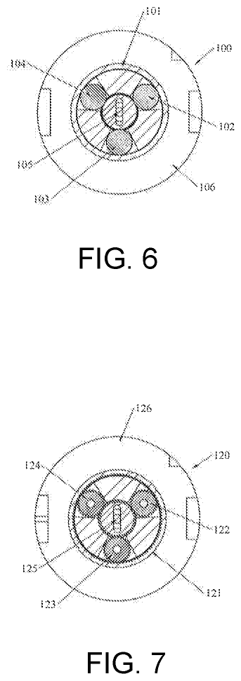

FIG. 6 is the same cross-section C-C identified in FIG. 2, only illustrating a different embodiment 100 wherein there is merely one adjustment wheel 102, 103 and 104 utilized per adjustment aperture, instead of the two adjustment balls per adjustment ball aperture configuration illustrated in FIG. 3.

FIG. 6 illustrates tool holder shank 106, an adjustment sun 105 and adjustment wheels 102, 103 and 104 (acting similar to planetary gears), to replace the adjustment balls shown in prior figures. In this embodiment, the internal surface of the adjustment ring 101 would interact with adjustment wheels 102, 103 and 104, which when rotated would cause adjustment sun 105 to rotate in similar fashion to the adjustment sun 27 rotation shown and described above in other embodiments.

FIG. 7 is the same cross-section C-C identified in FIG. 2, only illustrating a different embodiment 120 wherein adjustment gears 122, 123 and 124 replace the adjustment balls shown in FIG. 3. Illustrated in FIG. 7 is an embodiment of the invention in which, instead of using at least one adjustment ball as the driving mechanism (as illustrated in FIG. 3), a more traditional gear configuration could be used.

FIG. 7 illustrates tool holder shank 126, an adjustment sun gear 125, planetary gears 122, 123 and 124 around sun gear 125, wherein the gears replace the adjustment balls shown in prior figures. In this embodiment, the internal surface of the adjustment ring 121 would include gear interactive shapes (such as without limitation, gear teeth) and instead of an adjustment ball or adjustment wheel, it would be one or more adjustment drive gears 122, 123 and 124.

In another embodiment of the invention, instead of using two adjustment balls per adjustment aperture, one adjustment wheel could be utilized. In this embodiment a wheel shaped driver may be placed directly between the adjustment ring 28 and the adjustment sun 27, such that the adjustment wheel would act in a similar fashion to a single adjustment ball—for example the single wheel between the two would mean that the adjustment sun 27 (and consequently the adjustment screw) would rotate the opposite direction from the adjustment ring 28. In this wheel-based drive example, window-like configured adjustment wheel apertures would need to be provided instead of drilling the adjustment apertures for the adjustment balls.

As will be appreciated by those of reasonable skill in the art, there are numerous embodiments to this invention, and variations of elements and components which may be used, all within the scope of this invention. In one embodiment for example, a tool holder adjustment system is provided, comprising: a tool holder with an upper end configured to attach and detach to a machine spindle and a lower end configured to securely receive a tool; an adjustment ring rotatably mounted around the periphery of part of the tool holder; an adjustment sun rotatably mounted within the tool holder; at least one adjustment member rotatably mounted abutting and between the adjustment ring and the adjustment sun, and disposed such that the at least one adjustment member rotates in response to rotation of the adjustment ring and the adjustment sun rotates in response to rotation of the adjustment member; an adjustment key rotatably attached at a top end to the adjustment sun and rotatably attached at a bottom end to an adjustment screw; and an adjustment screw rotatably attached to the adjustment key and configured to interact with a tool directly or indirectly attached to the adjustment screw such that when the adjustment screw rotates relative to the tool, the tool is moved vertically.

In addition to the embodiment disclosed in the preceding paragraph, the invention may further include such a tool holder adjustment system: further wherein the at least one adjustment members are two in number; further wherein there are three of the at least one adjustment members around the tool holder (including without limitation, wherein the at least one adjustment members are two in number); further wherein the tool holder is configured to securely receive a tap; further wherein the tool holder is configured to securely receive a drill; and/or further wherein the rotational member is spherical-shaped further wherein the rotational member is wheel-shaped;

In addition to the embodiment disclosed in the second preceding paragraph, the invention may further include such a tool holder adjustment system further comprised of: a first rotational member operatively abutting an interior surface of the adjustment ring and configured to rotate in response to rotation of the adjustment ring; a second rotational member operatively abutting and between both the first rotational member and the adjustment sun, such that the second rotational member rotates in response to rotation of the first rotational member, and further configured such that the adjustment sun rotates in response to rotation of the second adjustment member; and without limitation, further wherein the first rotational member and the second rotational member are spherically-shaped.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A tool holder adjustment system comprising:
a tool holder with an upper end configured to attach and detach to a machine spindle and a lower end configured to securely receive a tool;
an adjustment ring rotatably mounted around the periphery of part of the tool holder;
an adjustment sun rotatably mounted within the tool holder;
at least one rotational adjustment member rotatably mounted abutting and between the adjustment ring and the adjustment sun, and disposed such that the at least one rotational adjustment member rotates in response to rotation of the adjustment ring and the adjustment sun rotates in response to rotation of the rotational adjustment member;
an adjustment key rotatably attached at a top end to the adjustment sun and rotatably attached at a bottom end to an adjustment screw; and
an adjustment screw rotatably attached to the adjustment key and configured to interact with a tool directly or indirectly attached to the adjustment screw such that when the adjustment screw rotates relative to the tool, the tool is moved vertically.

2. A tool holder adjustment system as recited in claim 1 and further wherein the at least one rotational adjustment members are two in number.

3. A tool holder adjustment system as recited in claim 1 and further wherein there are three of the at least one rotational adjustment members around the tool holder.

4. A tool holder adjustment system as recited in claim 3 and further wherein the at least one rotational adjustment members are two in number.

5. A tool holder adjustment system as recited in claim 1 and further wherein the tool holder is configured to securely receive a tap.

6. A tool holder adjustment system as recited in claim 1 and further wherein the tool holder is configured to securely receive a drill.

7. A tool holder adjustment system as recited in claim 1 and further wherein the rotational member is spherical-shaped.

8. A tool holder adjustment system as recited in claim 1 and further wherein the rotational adjustment member is wheel-shaped.

9. A tool holder adjustment system as recited in claim 1, further comprised of:
a first rotational adjustment member operatively abutting an interior surface of the adjustment ring and configured to rotate in response to rotation of the adjustment ring;
a second rotational adjustment member operatively abutting and between both the first rotational adjustment member and the adjustment sun, such that the second rotational adjustment member rotates in response to rotation of the first rotational adjustment member, and further configured such that the adjustment sun rotates in response to rotation of the second rotational adjustment member.

10. The tool holder adjustment system as recited in claim 9, and further wherein the first rotational adjustment member and the second rotational adjustment member are spherically-shaped.

11. The tool holder adjustment system as recited in claim 1, and further wherein the at least one rotational adjustment member is at least two rotational adjustment members, and is one of spherically-shaped, wheel-shaped and gear-shaped.

12. A tool holder adjustment system as recited in claim 1 and further wherein the rotational adjustment member is gear-shaped.
